(19) United States
(12) Patent Application Publication
(10) Pub. No.: US 2004/0003061 A1
(43) Pub. Date: Jan. 1, 2004

(54) Configuring alarms of clocks over a local area network

(76) Inventors: Louis Robert Litwin JR., Plainsboro, NJ (US); Kumar Ramaswamy, Plainsboro, NJ (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/186,006

(22) Filed: Jun. 28, 2002

(51) Int. Cl. G06F 15/16; G04C 21/00; G04C 23/00; G04B 23/02; G06F 15/177

(52) U.S. Cl. 709/220; 368/72; 709/208

(57) ABSTRACT

A method of alarm scheduling of an alarm clock over a local area network includes the steps of providing an alarm clock having a modem, the modem permitting communication with the alarm clock over a local area network; and receiving by the alarm clock an alarm scheduling information over the network, the alarm scheduling information including an alarm setting for the alarm clock for a particular time and day. A computer readable medium for providing information to a general purpose computer that schedules alarm settings on an alarm clock with a modem over a local area network includes displaying a calendar for an alarm clock with a modem connected to a local area network, providing a calendar interface by which an alarm setting on said alarm clock can be scheduled according to different days on the calendar, and sending over the network alarm information to the alarm clock.

### BACKGROUND

1. Technical Field

This disclosure relates to local area networks, and more particularly, to an apparatus and method for alarm scheduling of multiple clocks over a local area network.

2. Description of the Related Art

Current alarm clocks only allow the user to set the alarm for the next day. Setting different alarm times on clocks for weekdays and weekends is inconvenient since alarm clocks do not permit simplified data entry.

Therefore, a need exists for a central configuration of alarm settings of multiple clocks on a local area network, which can be either wired or wireless.

### SUMMARY OF THE INVENTION

A method of alarm scheduling of an alarm clock over a local area network includes the steps of providing an alarm clock having a modem, the modem permitting communication with the alarm clock over a local area network; and receiving by the alarm clock alarm scheduling information over the local area network, the alarm scheduling including an alarm setting for the alarm clock for a particular time and day.

A computer readable medium for providing information to a general purpose computer that schedules alarm settings on an alarm clock with a modem over a local area network includes displaying a calendar for an alarm clock with a modem connected to a local area network, providing a calendar interface by which an alarm setting on the alarm clock can be scheduled according to different days on the calendar, and sending over the local area network alarm information to the alarm clock.

### BRIEF DESCRIPTION OF DRAWINGS

These and other objects, features and advantages of the present invention will become apparent from the following detailed description of illustrative embodiments thereof, which is to be read in connection with the accompany drawings:

FIG. 1 is a block diagram showing a system for central configuration of alarms of clocks on a local area network in accordance with the present invention;

FIG. 2 is a block diagram showing a clock with an alarm to be set in accordance with an embodiment of the present invention;

FIG. 3 is a flow diagram showing an alarm scheduling device in accordance with an embodiment of the present invention.

### DETAILED DESCRIPTION OF PREFERRED EMBODIMENTS

The present invention provides for scheduling alarms on multiple clocks on a local area network. This may be accomplished by incorporating inexpensive modems into each of the clocks, for example a powerline modem. The alarm settings of multiple alarm clocks can be configured via a PC connected to a local area network. Alternatively, a stand alone controller device can be used. Using scheduling software on the PC, a user can pre-set the alarms for days/months in advance. Different settings can be used for weekdays, weekends, or special days (e.g., a day when the user has an early flight).

Modems allow data to be transmitted over the different media in a home or office. Powerline modems are a cost effective solution to carry such information. An attractive feature of powerline modems is that a device equipped with such a modem only needs to be plugged into an electric outlet in order to be able to transmit and receive data over the powerlines. By integrating a powerline modem into simple consumer electronic devices, these devices can interface with a PC that also has a powerline modem. The advantage is that the processing power of the PC can be used to control the consumer electronic devices. Other than adding the powerline modem, the consumer electronic device would not need any additional hardware since the PC will do all of the processing. According to the invention, use of software on a PC or stand alone device controller permits sophisticated scheduling of the alarm clocks in a home by using powerline modem technology. Another medium and modem technology can serve the same function.

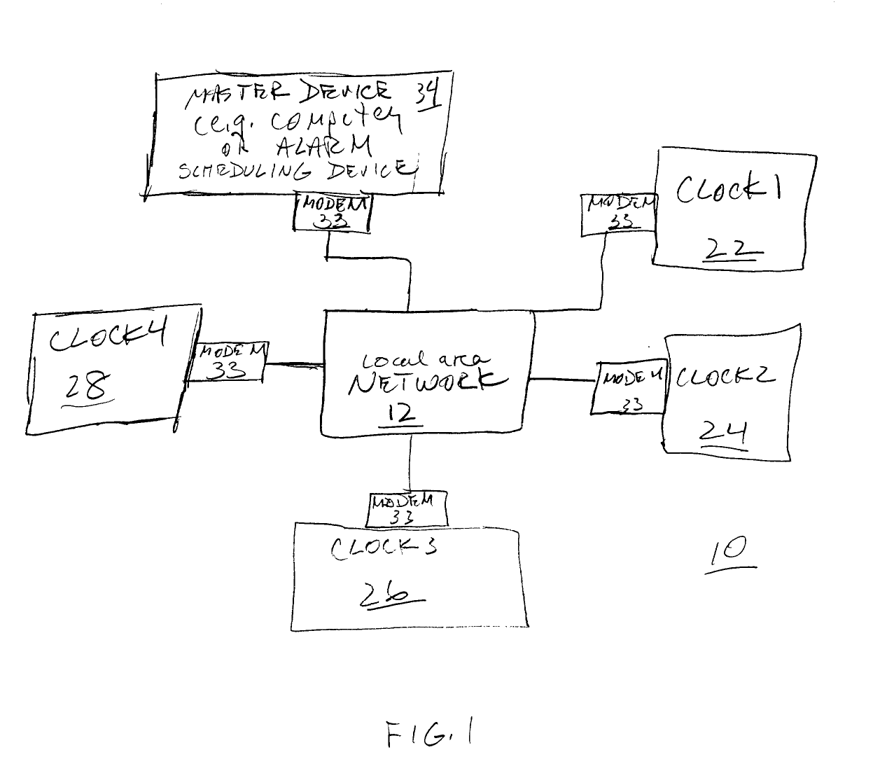

Referring now in specific detail to the drawings in which like reference numerals identify similar or identical elements throughout the several views, and initially to FIG. 1, a block diagram of an illustrative network 10 is shown in accordance with the present invention. A local area network 12, which may include a wired or wireless connection for a home or building, is connected to each of a plurality of clocks 22, 24, 26 and 28. The clocks include configurable alarm circuits (not shown). This list is not exhaustive and other devices may be connected to the local area network network. Each clock includes a modem 33, which permits communication between these clocks and a master device 34. Each clock also includes an alarm which may be configured for scheduled alarm activation. Master device 34 may include a personal computer or be a stand alone alarm scheduling device.

Software on the master device 34 (e.g., a PC) can allow convenient scheduling of the alarm times for all of the clocks in the home. The alarm clock software on the PC 34 would give the capability to pull up a calendar for each alarm clock in the house. This calendar interface would allow the scheduling of the alarm times for each alarm clock in the house. For example, the user could use the software to set the alarm clock to the same time for every weekday, and a later time for every weekend. If the user has to be at work early on Monday and doesn't want to forget, they can set an early time for just that particular Monday days or weeks in advance. If the family is taking a trip on a Saturday, all of the alarm clocks in the house can be set to go off early on that day. If someone wanted to use a traditional alarm clock to take a short afternoon rest, they would have to change the alarm time to, for example, half an hour from the current time, and then remember to change it back to his work alarm time when they get up. By using the software on the PC 34, the user can enable a short term selection in the software or device 34 that automatically sets the alarm for half an hour or an hour from the current time. Note that this would not interfere with the alarm setting for the next morning.

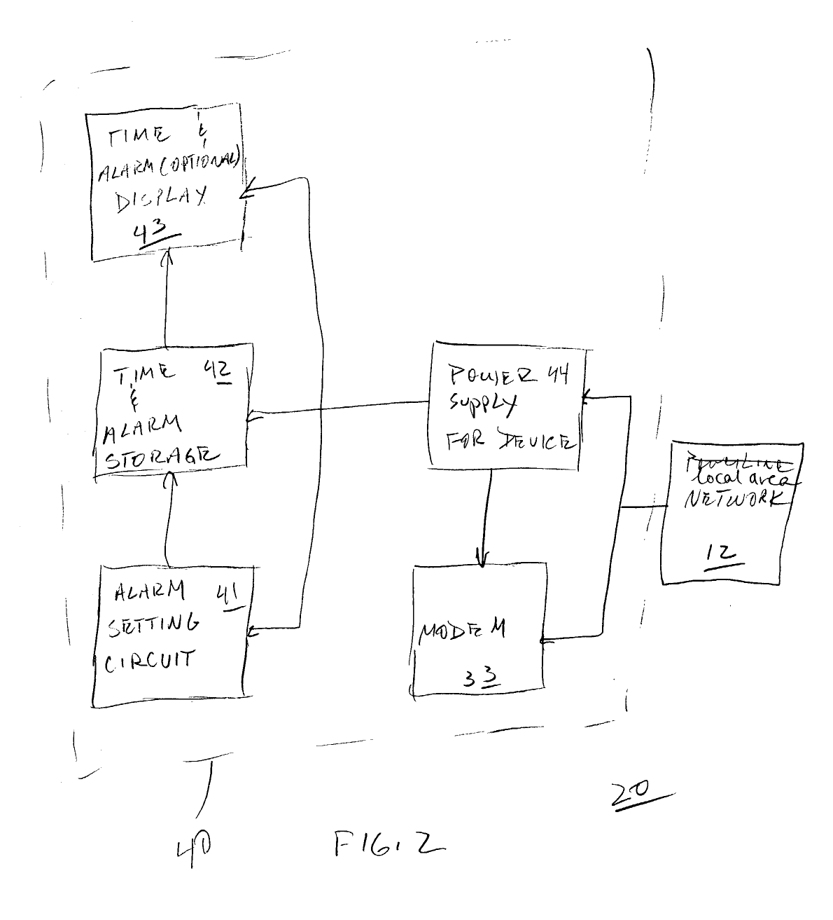

Referring to FIG. 2, a clock 40, such as one of clocks 22-28 in FIG. 1, includes a modem 33 connected to local area network 12. Modems 33 preferably include an embedded processor. The processor of modem 33 can run software whose functions include, but are not limited to, data modulation/demodulation as well as upper-layer network functions such as packet processing. A software routine can be added that processes the alarm scheduling clock information in an alarm setting circuit 41. The method by which the alarm setting is transferred to an alarm 42 depends on the implementation of the clock. Circuit 42 updates alarm storage in accordance with an alarm setting in a message. The alarm setting in alarm storage 42 is displayed in a time and alarm display 43. Also, a power supply 45 is employed to provide power to alarm storage 42 and modem 33.

Software on the PC 34 can allow the times on multiple alarm clocks 22-26 to be set simultaneously. This is a useful feature during a time-change or after a power failure. It is annoying to go around to each alarm clock in the home to change the time during both of the above mentioned events. This feature would allow all alarms to be changed to the same time quickly and easily. The typical way to set the time on an alarm clock is to push a certain button configuration, hold the buttons down until the correct time comes up, and let go. Missing the correct time means holding the buttons down again until the time loops around. With this feature, the time is set by simply typing in the time on the PC. Alternatively, the alarm clock software on the PC 34 can have an option to set all of the alarms in the house to the same time (if so desired).

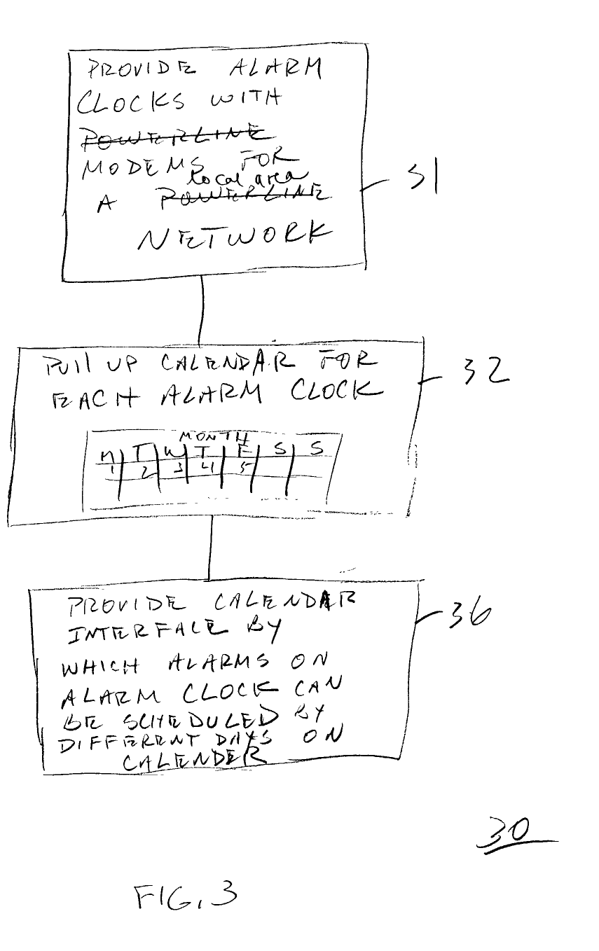

Referring to FIG. 3, the alarm clocks 22-26 with modem 33 are interconnected over the local area network 12 to the master device 34 in an exemplary embodiment. A calendar for a particular alarm is pulled up on the PC display 32. The PC's calendar display includes an interface 36 by which settings on clocks 22-28 can be scheduled on the calendar.

By using modem enabled alarm clocks 22-28 connected to a PC 34 over the local area network 12, alarm times can be set and organized. A calendar interface on the PC 34 can be used to set the alarm times for all alarm clocks for multiple days in advance. The calendar interface on the PC 34 can be used to set different patterns for the alarm settings (e.g., one time for all weekdays, one time for all weekends). A calendar interface on the PC 34 can be used to set an alarm time for a particular day that overrides prior settings.

Having described a preferred embodiment for alarm clock schedules over a powerline modem network for multiple alarm clocks (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. A method of alarm scheduling of an alarm clock over a local area network, comprising the steps of:
providing an alarm clock having a modem, the modem permitting communication with the alarm clock over a local area network; and
receiving by the alarm clock an alarm scheduling information over the local area network, the alarm scheduling information including an alarm setting for the alarm clock for a particular time and day.

2. The method as recited in claim 1, wherein said local area network includes one of a wired network, a wireless network, a combination wired and wireless network, a powerline modem network, and an ethernet.

3. The method as recited in claim 1, wherein the alarm scheduling information is derived from a calendar schedule for the alarm clock.

4. The method as recited in claim 1, wherein the alarm scheduling information sets the alarm times for the alarm clock for multiple days in advance.

5. The method as recited in claim 1, wherein the alarm scheduling information sets different patterns for alarm settings varying with different days of the week.

6. The method as recited in claim 5, wherein the different patterns include one alarm setting for weekdays and a second alarm setting for weekends.

7. A computer readable medium for providing information to a general purpose computer that schedules alarm settings on an alarm clock with a modem over a local area network comprising:
displaying a calendar for an alarm clock with a modem connected to a local area network,
providing a calendar interface by which an alarm setting on said alarm clock can be scheduled according to different days on the calendar, and
sending over the local area network alarm information to the alarm clock.

8. The method as recited in claim 7, wherein the alarm scheduling information sets the alarm times for the alarm clock for multiple days in advance.

9. The method as recited in claim 8, wherein the alarm scheduling information sets different patterns for alarm settings varying with different days of the week.

10. The method as recited in claim 9, wherein the different patterns include one alarm setting for weekdays and a second alarm setting for weekends.

11. The method as recited in claim 7, wherein the local area network comprises one of a wired network, a wireless network, a combination wired and wireless network, a powerline modem network and an Ethernet.

12. The method as recited in claim 7, wherein the alarm information is sent to multiple clocks with modems on the local area network to simultaneously set alarms for said multiple clocks.
